(19) United States
(12) Patent Application Publication
(10) Pub. No.: US 2005/0015330 A1
(43) Pub. Date: Jan. 20, 2005

(54) Method for enabling risk management for sellers of items on internet auction sites

(76) Inventors: Peter Douglas Beery, Cedar Park, TX (US); Robert A. Susskind, Oak Hill, VA (US)

Correspondence Address: Robert Susskind;c/o Alan Tiras, Esq., Suite 201, 264 Village Blvd., Incline Village, NV, 89451-7477, US

(21) Appl. No.: 10/874,605

(22) Filed: Jun. 23, 2004

Related U.S. Application Data
(60) Provisional application No. 60/485,950, filed on Jul. 11, 2003.

(51) Int. Cl. G06F 17/60

(52) U.S. Cl. 705/38

(57) ABSTRACT

A method for enabling risk management for sellers of items on Internet auction sites with the steps of: Automatically detect new bids on auctions, Evaluate bidders on the basis of their past performance using an artifical intelligence system, Maintain on a central server rating information for bidders, Maintain on the central server a seller's preferences for dealing with bidders in each rating category, Based upon the rating act on the auction by: canceling bid, notifying seller, or accepting the bid, Based upon the bidder's country of registration notify the seller, Allow sellers to see all auctions with bidders on one screen, Allow sellers to see a list of other auctions where their bidders have placed bids, Automate auction fee refund processing, and Allow sellers to see a list of all pending and recently completed auction refund requests, allow anonymous reprisal-free bidder feedback.

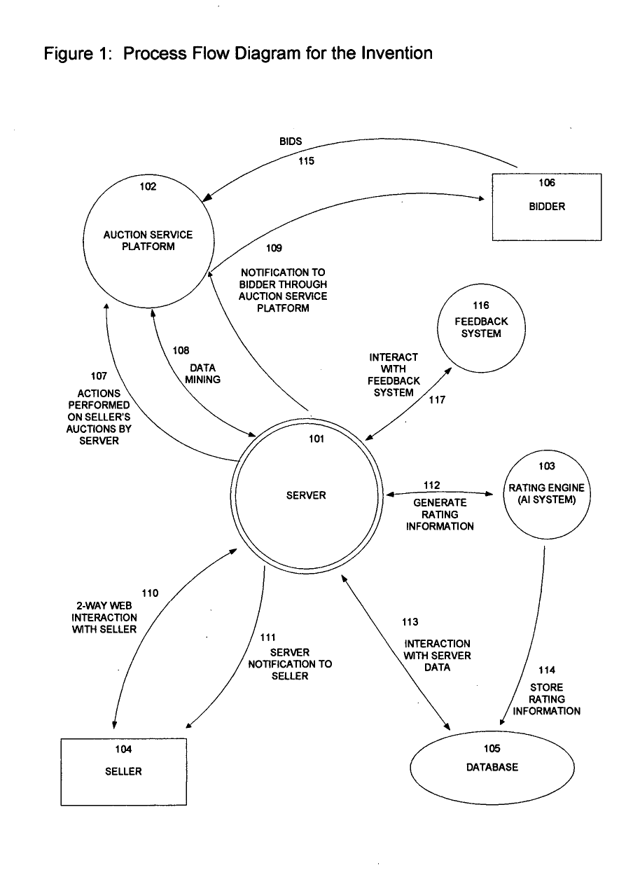

### CROSS REFERENCE TO RELATED APPLICATIONS

This application is based on provisional application Ser. No. 60/485,950, filed on Jul. 11, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of risk and more specifically to a method for enabling automated and semi-automated risk management for sellers of items on Internet auction sites.

The inventor spent time as an online auction seller. He realized that sellers are often victimized by winning bidders who do not complete the purchase of items, or, who are very difficult to deal with during or after an auction. This class of bidder is colloquially known as a ‘deadbeat’ bidder. These ‘deadbeat’ bidders were observed to come in many different varieties. Some were acting maliciously, some were clearly “shopping” by bidding on multiple auctions but intending to complete only one, others were difficult to work with or slow to respond to communications, and so forth. In general, this type of bidder causes the seller significant extra work, and expense. At the same time, the venue of online auctions is itself a relatively new technology which lends itself well to an innovative solution such as is represented by this invention. Online auction market places have their data available in a format that can be extracted with standard internet technologies. The core of this invention, is essentially a set of services and artifical intelligence processes which perform data mining actions on the auction service platform and which further interacts with the auction service platform on the behalf of a seller to take various actions such as removing bids based upon an individual seller's stored preferences and the risk assessment (here after called ‘rating’) calculated by the invention for each bidder on the seller's auctions. These actions occur in near real time. Prior to this invention, the only tools available to a seller were manual data look up on a bidder by bidder basis using the simple tools supplied by the online auction platform service provider. No automated data mining or analysis tools for risk analysis were available.

The prior technology was labor intensive and required each seller to monitor his or her auctions on a 24 hour basis for new bids and then to manually evaluate the quality of that bidder. Although the losses associated with ‘deadbeat’ bidders is quite real (it runs at around 3.7% currently on the industry leading public online auction platform), the labor required to filter out these bad bidders was too much for many sellers.

### BRIEF SUMMARY OF THE INVENTION

The primary object of the invention is automatically Identify low quality bidders.

Another object of the invention is automatically Identify high quality bidders.

Another object of the invention is automatically Identify new bidders to the auction.

Another object of the invention is automatically Identify inexperienced bidders.

A further object of the invention is automatically Identify bidders from different global geographical regions.

Yet another object of the invention is Identify bids on similar auctions by the same bidder who placed a bid on a Seller's auction.

Still yet another object of the invention is Provide a venue for leaving anonymous reprisal-free feedback related to bidders.

Another object of the invention is Provide Sellers a configurable means to automatically remove bids from bidders, or notify sellers, or notify bidders according to the seller's stored preferences.

Another object of the invention is Simplify the process of requesting auction listing fee refunds for auctions where the transaction between Seller and high bidder did not complete.

Other objects and advantages of the present invention will become apparent from the following descriptions, taken in connection with the accompanying drawing, wherein, by way of illustration and example, an embodiment of the present invention is disclosed.

In accordance with a preferred embodiment of the invention, there is disclosed a method for enabling risk management for sellers of items on Internet auction sites comprising the steps of: Automatically detect new bids on auctions, Evaluating bidders on the basis of their past performance on other auctions giving more weight to more recent auctions using an artifical intelligence rating engine (a handcrafted ‘expert system’), Maintain on a central server rating information for bidders, Maintain on the central server a seller's preferences for dealing with bidders who fall into each of several rating categories, Based upon the seller's preference settings and a bidder's calculated rating take one or more of the following actions: cancel bid, notify seller, notify bidder to contact seller, block the bidder from bidding on any of the seller's auctions, or accept the bid, Based upon the seller's preference settings and the bidder's country of registration, accept the bid, or notify the seller, notify bidder to contact seller, and/or block the bidder from bidding on any of the seller's auctions, Allow sellers to see all rated bidders for all open auctions on one screen (web page), Allow sellers to see a list of other auctions that any bidders on the seller's auctions have placed bids, Automate auction fee refund processing for failed auctions such that the seller needs only to request the refund once, Allow sellers to cancel a pending auction fee refund request, Allow sellers to see a list of all pending and recently completed auction refund requests on one screen (web page), and Allow sellers to leave reprisal-free feedback for bidders.

### BRIEF DESCRIPTION OF THE DRAWING

This drawing constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention relates generally to the field of risk and more specifically to a method for enabling automated and semi-automated risk management for sellers 104 of items on Internet auction sites (aka auction service platforms) 102.

The core of this invention, is essentially a set of services 101 and artifical intelligence (a hand crafted ‘expert system’) processes (aka Rating Engine (AI system)) 103 which perform data mining actions 108 on the auction service platform 102. These services interact 107 with the auction service platform 102 on the behalf of a seller 104 to take various actions 107 such as removing bids based upon an individual seller's stored preferences 105 and the risk assessment (here after called ‘rating’) calculated by the rating engine 103 for each bidder 106 on the seller's auctions on the auction service platform 102. These actions occur in near real time (roughly 1-30 minutes).

Prior to this invention, the only tools available to a seller were manual data look up on a bidder by bidder basis using the simple tools supplied by the online auction platform service provider. No automated data mining or analysis tools for risk analysis were available. The automation of these risk management activities as is accomplished in the scope of this invention offers a clear advantage over the prior art in terms of reduced effort on the part of the seller and reduced monitary losses due to previously undetected high risk bidders and the associated higher rate of auction transactions not completed after a winning bid was determined at the close of the auction.

In accordance with a preferred embodiment of the invention, there is disclosed a method for enabling risk management for sellers 104 of items on Internet auction sites 102 comprising the steps of: Automatically detect new bids on auctions 108. Automatically evaluate 103 bidders 106 on the basis of their past performance on other auctions 108 giving more weight to more recent auctions using an artifical intelligence system (in this example, a handcrafted ‘expert system’) aka rating engine 103. Maintain at a central server 101 rating information 105 for bidders 106. Maintain on the central server 101 a seller's preferences 105 for dealing with bidders 106 who fall into each of several rating categories. Based upon the seller's preference settings 105 and a bidder's calculated rating 112 the server 101 will take one of the following actions 107: cancel bid, block bidder, notify seller 111, notify bidder to contact seller 109, or accept the bid. Based upon the seller's preference settings 105 and the bidder's country of registration 105 the server 101 will: accept the bid, cancel the bid, block the bidder, or notify the seller 104. Allow sellers 104 to see all rated bidders 106 for all open auctions on one screen (web page) 110. Allow sellers 104 to see a list of other auctions 110 on which bidders 106 on the seller's auctions have placed bids 115. Automate on the server 101 auction fee refund processing 107 for failed auctions such that the seller 104 only needs to request the refund once 110. Allow sellers 104 to cancel a pending auction fee refund request through the server 101. Allow sellers 104 to see a list of all pending and recently completed auction refund requests on one screen (web page) 110. Allow sellers to leave anonymous reprisal-free feedback 117 on the server's feedback system 116 for bidders 106.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method for enabling risk management for sellers of items on Internet auction sites comprising the steps of: Automatically detect new bids on auctions; Automatically evaluate the risk associated with these bidders by way of their past performance on other auctions giving more weight to more recent performance using an artifical intelligence system which analyses records of previous auctions (including seller and customer feedback reports) for indications that the bidder will or will not complete the transaction for auctions which they win; and automatically taking actions to cancel the bid, or alternately notify the seller, or alternately notify to the bidder to contact the seller, and/or alternately block the bidder from making further bids on the seller's auctions.

2. A method for enabling risk management for sellers of items on Internet auction sites as claimed in claim 1 further comprising: an assessment of the bidder's country.

3. A central server system supporting the methods described in claims 1 and 2 comprising the following elements and functions: A webserver containing secured web pages enabling a seller to view a list of auctions with rated bidders listed; additional web pages enabling the seller to view a list of auction fee refund requests; additional web pages enabling the seller to view and submit anonymous feedback for bidders; additional web pages enabling the seller to manage their preferences for bidder rating related actions; additional web pages enabling the seller to see a list of other auctions that a bidder on the seller's auction has also placed bids with; a database supporting the data related functions of the central server; and a artifical intelligence system based risk rating engine.

4. A central server system supporting the methods described in claims 1 and 2 as claimed in claim 3 further comprising: A set of background tasks and system services which run on a regular and varied schedule which monitor each seller's auctions for new bids and automatically retrieve web pages from the online auction service platform; and a set of background tasks and system services which run on a regular and varied schedule which automatically perform actions on the online auction service platform on the behalf of the seller.

5. A central server system supporting the methods described in claims 1 and 2 as claimed in claim 3 further comprising: A set of background tasks and system services which run on a regular and varied schedule which monitor each seller's auctions for new bids and automatically retrieve web pages from the online auction service platform; and a set of background tasks and system services which run on a regular and varied schedule which automatically perform email notification actions to the seller or bidder on the behalf of the seller.

6. A central server system supporting the methods described in claims 1 and 2 as claimed in claim 3 further comprising: A set of background tasks and system services which run on a regular and varied schedule which monitor each sellers auctions for new bids and automatically retrieve web pages from the online auction service plafform; and a set of background tasks and system services which run on a regular and varied schedule which automatically perform instant messenger notification actions to the seller or bidder on the behalf of the seller.
